(19) United States
(12) Patent Application Publication
(10) Pub. No.: US 2012/0158304 A1
(43) Pub. Date: Jun. 21, 2012

(54) Evaluating a Situation of Being Exposed to Environmental Risk

(75) Inventors: Jean-Marie Fauquant, Gif Sur Yvette (FR); Hubert Lelache, Orsay (FR); Yann Kacenelen, Villabe (FR); Olivier Gerphagnon, St Germain Les Corbeil (FR)

(73) Assignee: Commissariat A L'Energie Atomique Et Aux Energies Alternatives, Paris (FR)

(21) Appl. No.: 13/394,059

(22) PCT Filed: Sep. 3, 2010
(86) PCT No.: PCT/FR10/51842

§ 371 Date: Mar. 2, 2012

(30) Foreign Application Priority Data
Sep. 4, 2009 (FR) 09 56047

(51) Int. Cl. G06F 19/00

(52) U.S. Cl. 702/3; 702/1

(57) ABSTRACT

The invention enables the evaluation of a situation of an area being exposed to risk by performing measurements at various points of the area. For this purpose, a risk propagation area is estimated over the area. Then, a subset of measurement points is selected from among the various points of the area which are also in the risk propagation area. Assignments for performing measurements at the subset points are planned.

The invention relates in general to evaluating a situation of exposure to risk in a given geographical area. In particular, the invention has applications in the planning, consolidation, and distribution of measurements at different points of an area in which a facility is located that is capable of releasing potentially hazardous products.

Some industrial sites contain substances which pose a risk to the environment or to nearby populations. An accident can cause a release of these substances in areas around the site.

To respond effectively to such an occurrence, action plans must be carried out under the direction of the persons in charge. These persons therefore must be provided with knowledge of the situation in the area concerned as quickly as possible, particularly the level of exposure to the risk at different points in the area. An assessment of the situation must precede the planning of any intervention, and determines its extent and importance.

To obtain a reliable assessment, it is necessary to conduct a large number of measurements at regular intervals according to a protocol which may be quite complex, and over an extensive portion of the area concerned. These measurement campaigns may require the involvement of multiple teams from multiple fields of expertise, whose safety must be guaranteed. The different measurements obtained must be consolidated and validated before distribution. It is therefore easy to understand why planning these measurement campaigns is a particularly complex task. The various parties concerned must be given access to the results obtained from these campaigns as rapidly as possible. In general, the effectiveness of the response to a crisis situation greatly depends on the time required to plan these measurement campaigns and to distribute the information collected.

The invention aims to improve the situation. A first aspect of the invention proposes a method for evaluating a situation of exposure to risk in an area by conducting measurements at different points in the area. The method comprises the following steps:
estimating a risk propagation area within the area, based on at least: on one hand, information issuing from measurements on the type and extent of the risk; and, on the other hand, on environmental and/or meteorological data such as the speed and direction of the wind within said area starting at an initial time;
selecting a subset of points, from among the different points in the area, also contained in the risk propagation area;
planning measurement tasks at the points of the subset.

Thus, by estimating a risk propagation area for the area, it is possible, without any loss of effectiveness or reliability, to limit the measurement campaign to a limited area of the area concerned. It is possible for the same number of operators, for example, to obtain measurements more frequently and more quickly where the risk is actually present.

The measurements at the different points of the area may be radiological measurements, and the risk propagation area is then estimated on the basis of the environmental and/or meteorological data, such as, for example, a measurement of the speed and direction of the wind within the area.

The method according to the first aspect of the invention may further comprise a step of receiving, validating, and storing the measurements made during the planned measurement tasks.

Thus, upon transmission of the measurements by the operators, the measurements can be validated by technical experts, which contributes to the prompt exclusion of inconsistent measurements and to obtaining a more representative situation assessment. The validation can begin upon receipt of the measurements, without awaiting the operators' return, which facilitates comparisons for validation between measurements made by different operators.

The method according to the first aspect may further comprise a step of receiving, validating, and storing measurements made during the planned measurement tasks. The measurements made during the measurement tasks are, for example, validated by verifying the consistency of each measurement as a function of its evolution over time and/or its consistency relative to other measurements obtained nearby.

By providing a summary view of the situation for the area based on the stored measurements, the distribution of important information to the decision makers is accelerated, which ultimately allows faster decision making and therefore a more effective intervention.

The method according to the first aspect may also comprise a step of constructing and providing a summary view of the situation in the area, based on the stored measurements. The summary view of the situation in the area comprises, for example:
a map of the area comprising a representation of the risk propagation over time;
representations over time, in text, table, and/or graphical form, of the measurements previously obtained.

In the first aspect of the invention, the different points in the area may be predefined.

In the first aspect of the invention, the measurement tasks at the points can be planned by assigning, to the operators, task assignments comprising the following information:
one of the points in the subset;
a type of measurement to be performed;
a measurement device to be used.

The method according to the first aspect of the invention can be carried out in the context of a simulation exercise.

A second aspect of the invention proposes a computer program comprising instructions for implementing the method according to the first aspect of the invention when this program is executed by a processor.

A third aspect of the invention proposes a system for evaluating a situation of risk exposure in an area.

A fourth aspect of the invention proposes a measurement device for a system according to the third aspect of the invention.

Other aspects, features, and advantages of the invention will be apparent from reading the following description of one of its embodiments.

The invention will also be better understood by examining the drawings, in which:

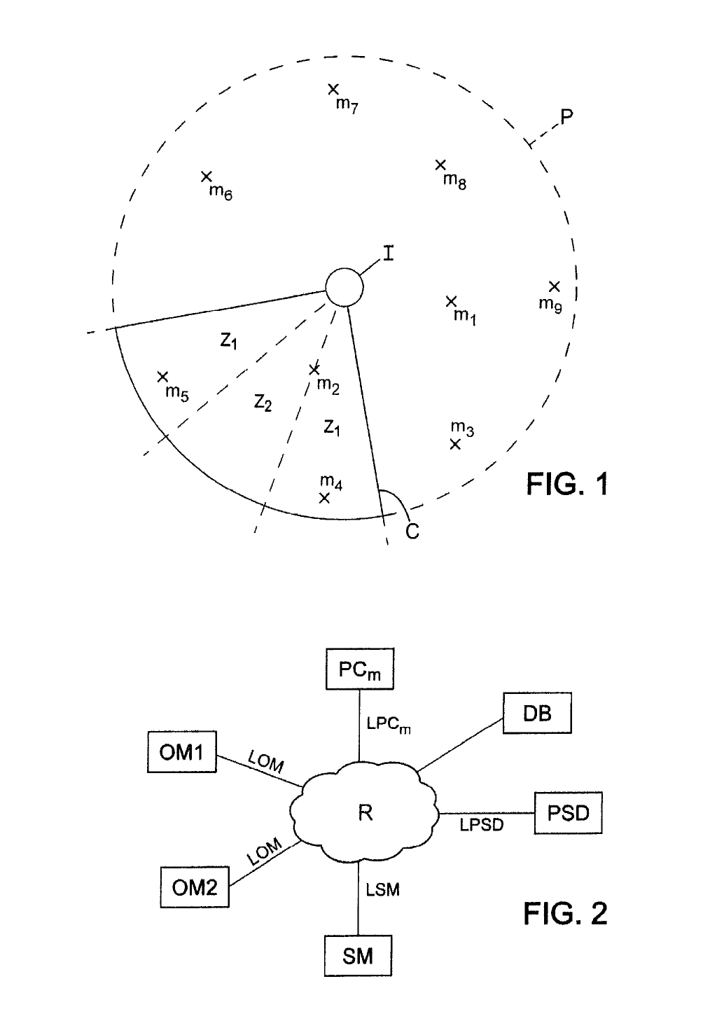

FIG. 1 shows a geographical area in which exposure to a known risk is possible;

FIG. 2 shows a schematic diagram of a system for establishing and distributing a summary overview of the risk exposure, according to an embodiment of the invention;

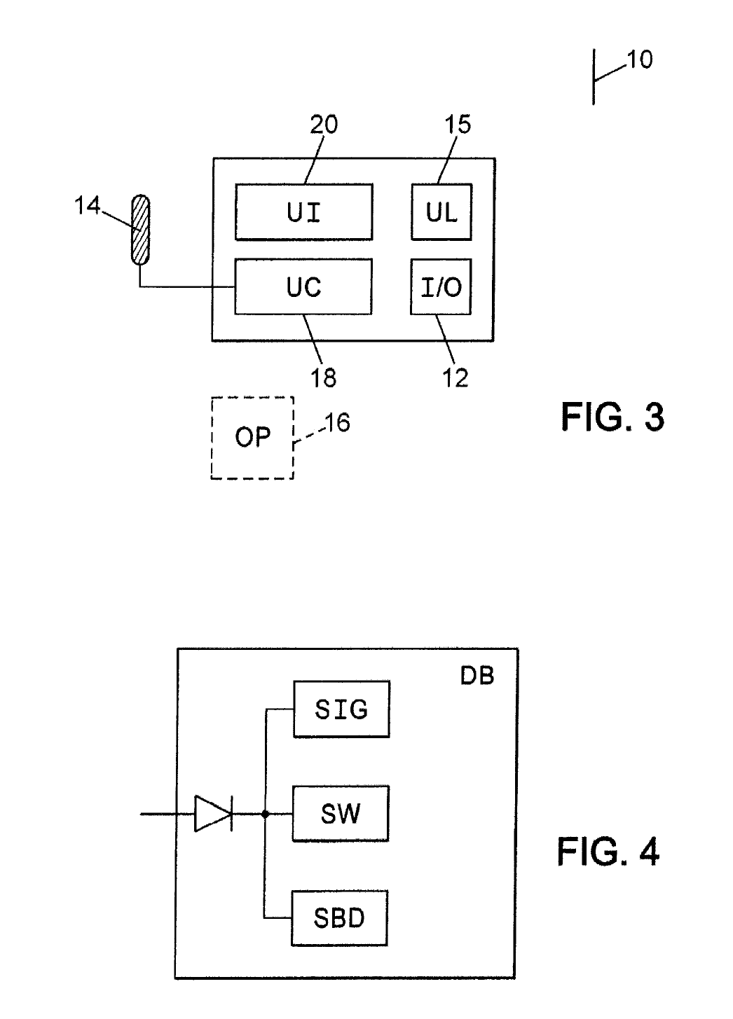

FIG. 3 shows a schematic diagram of a measurement device according to an embodiment of the invention;

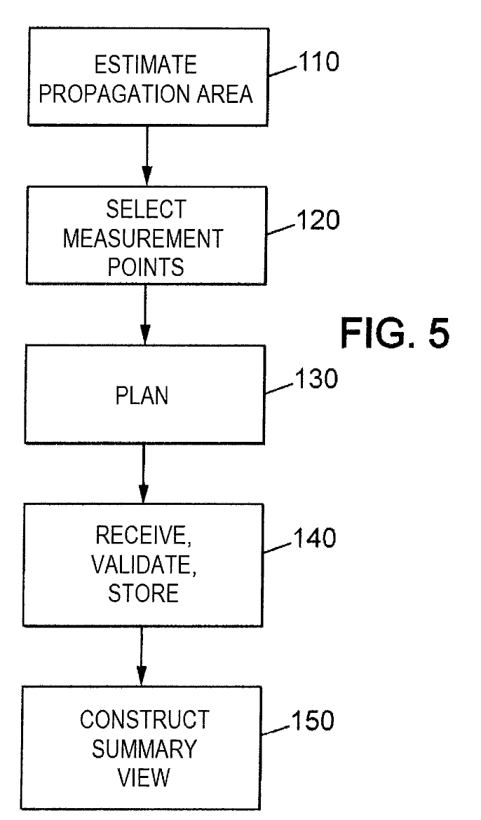

FIG. 4 shows a schematic diagram of a measurement storage center according to an embodiment of the invention;

FIG. 5 shows a block diagram of the main steps of a method for establishing and distributing a summary overview of exposure to a risk in a geographical area, carried out according to one embodiment of the invention.

The present description considers a facility I in a given geographical region, as illustrated in FIG. 1. It is possible for the facility I to expose an area P of the geographical region to a known risk. This risk can be assessed based on physical measurements conducted at different points m of the area P. As a non-limiting example, the facility I may be an industrial or scientific complex which contains radioactive materials. As a function in particular of the amount of radioactive materials and the topology of the geographical region, the area P is defined, for example, as a disk centered around the facility I and having a radius corresponding to the largest distance that a significant amount of radioactive materials held within the facility I could reach following an accidental release. As an example, from the facility I and as a function of the risk, based on expert assessments, a radius is established to define the area P in the context of a particular response plan. The inherent risk in the spread of radioactive materials, particularly the risk to the environment and to the populations present in the area P, is assessed by conducting radiological measurements at different points m in the area P.

More generally, the facility I may be defined as a potential source of products having physical characteristics which can be measured at different points m in the area P. The facility I may be a potential source of harmful or pollutant liquids and/or gases, including a source of viral or bacteriological materials as it is known that such a hazard may spread in aerosol form in certain cases.

The system for evaluating a situation of risk exposure in an area, according to an embodiment of the management invention as represented in FIG. 2, comprises a network structure R which interconnects the different components of the system. The network infrastructure R is, for example, a network infrastructure for computerized communication, preferably making use of the same communication protocol and in particular which can transport data, such as the Internet.

The system comprises measurement devices 10. An example of such a measurement device is illustrated in FIG. 3. The measurement devices 10 are portable, and can be transported and manipulated by an operator. Operator is understood to mean any entity able to operate the measurement devices 10, for example a technician, a radio-controlled and/or automated device.

Each measurement device 10 comprises a network interface 12 able to establish a connection LOM with the network infrastructure R. As an example, the connection LOM may be a wireless connection such as GSM, GPRS, Wimax, UMTS, TETRA, TETRAPOL, etc. In addition, each measurement device comprises at least one sensor 14 able to obtain physical measurements to assess the risk. In the case of a risk related to the presence of a radioactive element in the environment, the sensor is typically a sensor for measuring ionizing radiation which is alpha, beta, gamma, or X-ray radiation. The measurement device comprises a locator unit 15, for example in the form of a module for processing GPS signals, which allows the device to know its geographical position, particularly within the area P. The measurement device optionally comprises sample collection tools 16 for gathering samples of materials likely to have been exposed to the hazard. To supplement the direct measurements obtained using the sensor 14, samples collected using the sample collection tools 16 allow later indirect analyses by means of devices which cannot be quickly and easily deployed in the field.

The measurement device further comprises a calculation unit 18 which in particular cooperates with an optional user interface 20, the network interface 12, and the locator unit 15. The user interface 20 is particularly useful when the operator is a person. The user interface 20 may comprise a touch screen, a data entry device such as a keyboard, or any other device allowing an operator to perform the conventional tasks of entering, navigating, and viewing data. The calculation unit 18, the user interface 20, the network interface 12, and the locator unit 15 can be combined within the same portable device and designed for handling in the environmental and operating conditions of the location where the measurements are to be performed. For example, this device may be in the form of a portable computer, such as a rugged touch pad equipped with a processor, a touch screen, a GPS module, and network interfaces. The calculation unit 18 is able to execute a program which in particular allows:
displaying an interactive map of the area P on the user interface 20, in particular a map comprising symbols to show the location of the different points m of the area P;
providing instructional and task sheets;
capturing, storing, and displaying measurements obtained using the sensor 14;
sending measurements over the network interface 12 as well as information concerning the measurements, which may include the time and location for these measurements;
providing a log which records the history of events as well as the operations performed.

The map represents the area P by indicating in particular the means of access to the points m where the measurements are to be conducted. In conjunction with the locator unit, the map can express the current position of the operator, the position of one of the selected points m, and an itinerary between the current position and the position of the selected point m. The map is typically stored on the measurement device.

The instructional and task sheet contains information concerning the measurement points, particularly a geographical position of these points possibly combined with an address, an itinerary starting from the facility I, a list of the measurements that must be conducted at each point, and an operating procedure. The instructional and task sheet is typically stored on the measurement device.

Depending on the type of sensor 14, the measurements conducted by an operator may be entered using the user interface 20 or transmitted automatically by the sensor to the calculation unit 18. These measurements are then stored with a possible comment and can subsequently be viewed. The measurements can then be transmitted to the network interface 12, either at the request of the operator or automatically after the data is acquired.

In FIG. 2, two groups OM1 and OM2 of measurement devices 10 have been represented. Typically, the measurement devices 10 belonging to group OM1 can be given to operators in a first unit, while those of group OM2 are assigned to operators in a second unit. Each unit can have specific technical characteristics such as the means of travel (in particular ground or air), travel speed, the extent of the area within which it can work (for example the height), type and degree of protection (particularly for the hazard to which it may be exposed during the measurement so that it can carry out the task properly).

The system may optionally comprise measurement stations SM. Each measurement station comprises at least one sensor able to obtain physical measurements for assessing the risk, a network interface able to establish a connection LSM to the network infrastructure R, and a calculation unit for connecting the sensor to the network interface. Each measurement station is arranged in a fixed manner at one of the points m of the area P and is programmed to send automatically, without operator intervention, the measurements obtained by the sensor. The measurement stations SM, which are fixed, can perform measurements continuously and if needed can send an automatic alert over their connection LSM upon detection of the hazard in the covered area P.

The system comprises a measurement storage center DB, as represented in FIG. 4. The storage center DB generally comprises a firewall to filter the data received from and sent to the network infrastructure R. It also comprises a database server SBD, a geographical information server SIG, and a web server SW. The database server SBD in particular comprises storage peripherals and a database management system for storing the measurements and information associated with them, in particular the time and geographical information, sent by the measurement devices 10 over the connection LOM and by the measurement stations SM over the connection LSM. The geographical information server SIG comprises peripherals for storing geographical data for the area P as well as calculation units for creating a graphical representation of the area P upon request, based on said geographical data. The graphical representation of the area P may in particular comprise graphical symbols representing the points m as well as a representation of the measurements contained in the database server SBD. The web server SW comprises a program for responding to user requests, in particular by generating pages containing a summary view of the situation in the area P, based on measurements stored in the database server SBD. Thus the web server SW, cooperating with the database server SBD and the geographical information server SIG, allows sending one or more summary pages for measurements to a user who wants to know how the measurements obtained at points m in the area P are evolving over time. These pages could contain, for example, a map of the area P as well as tables and graphical representations such as curves, histograms, or pie charts representing these data.

The system comprises at least one measurement control center PCm. This center comprises a storage peripheral, a calculation unit, a user interface, a viewing device, and a network interface for establishing a connection LPCm to the network infrastructure R, to allow:
storing the list of available measurement devices, using for example their serial number, as well as the properties of these devices such as the type of sensor used;
verifying the exposure each operator has undergone;
planning and assigning task assignments to the operators, indicating for example one of the points m and the type of measurement that the operator is to perform, as well as the measurement device which is to be used, the time and the priority corresponding to this task, etc.;
validating the measurements already performed.

The measurement control center PCm, via its network interface, can access the map of the area P as well as the measurements previously conducted, by sending a request to the database server SDB. The measurement control center PCm is in particular able to:
estimate a risk propagation area C in the area P;
select a subset of points m, from among the different points m of the area P, which are also contained in the risk propagation area C;
plan measurement tasks at the points m of the subset.

The risk propagation area C is estimated, for example, on the basis of a measurement of meteorological conditions, or in particular on the basis of a measurement of the speed and direction of the wind within the area P. In the case of a radiological hazard, based on the knowledge of the amount of radioactive material likely to have been released and the speed and direction of the wind, it is possible to estimate a risk propagation area C corresponding to a section of disk (represented in FIG. 1) where the tip corresponds to the position of the facility I, and the area is determined as a function of the speed and direction of the wind. The risk propagation area C, corresponding in this example to a propagation cone, can be determined using an atmospheric propagation model, for example a Gaussian model of the atmospheric dispersion such as a Turner or Pasquill or Doury model. The Doury model is, for example, described in the article “A design basis for the operational modeling of atmospheric dispersion”—André Doury—Journal of Loss Prevention in the Process Industries—Volume 1, Issue 3, July 1988, Pages 156-163. A comparison of the different models is also presented in the report: “A review of dispersion modelling and its application to the dispersion of particles: An overview of different dispersion models available”—N. S. Holmes, L. Morawska—International Laboratory for Air Quality and Health, Queensland University of Technology, GPO Box 2434, Brisbane Qld, 4001, Australia. Tasks are then only planned for the m points of the area P which are also contained in that disk section. In the example in FIG. 1, these are points m₂, m₄, and m₅. It is also possible to subdivide the disk section C into different subsections, for example two subsections Z₁ and Z₂, each subsection being reserved for the measurement tasks assigned to one of the operator groups. The measurement control center PCm also allows validating a measurement. Thus each measurement can be in a “validated” or non-“validated” state. The validation can in particular concern verifying the measurement consistency, as a function of its evolution over time and/or its consistency relative to measurements obtained nearby.

The system comprises a monitoring and decision center PSD. This center comprises a calculation unit, a viewing device, and a network interface for establishing a connection LPSD to the network infrastructure R. The monitoring and decision center PSD can access the map of the area P as well as the measurements previously obtained, by sending a request to the database server SDB via its network interface. The users of the monitoring and decision center PSD then have access to a summary view of the situation, and can decide on the actions to take concerning the risk.

FIG. 5 shows a block diagram of the main steps of a method for establishing and distributing a summary assessment of the risk exposure in a geographical zone, implemented according to an embodiment of the invention. Initially there is a map of the area P around the facility I, on which the measurement points m are represented. The points m are predefined, in particular in a manner which allows an operator to obtain a measurement and guarantee sufficient representativeness of the set of measurements. It is thus possible, for example, to define the position of the points m by:
defining a grid or lattice covering the area P and having nodes that are regularly distributed or distributed according to a statistical law;
positioning a point m at each node, unless the position of said node corresponds to an inappropriate point for obtaining a measurement (for example inaccessible or on private property). In such case, a position is chosen for the point m which is likely to be suitable and is close to said node.

Typically, the points m are distributed over the area P using a layout consisting of pie-shaped sections of 20-25° with their tips centered on the facility I, the points m being positioned at regular intervals, every 500 m for example. The position of the points m is then adjusted to exclude the measurement points which are inaccessible or difficult to access for operators. The position of the points m can also be adjusted according to criteria such as population density, presence of waterways, accessibility, the nearby presence of an area requiring special attention (population, waterway, etc.).

The priori knowledge of the points m enables a rapid and reliable implementation of measurement operations, by allowing advance planning of the appropriate measurement protocols and itineraries. However, the points m may be supplemented during the operation with new measurement points in order to increase the number of measurements in a particular area. Thus the number and position of the points m can be adapted to evolutions in the risk propagation and any changes in the nature of the risk.

Below is an example of an accident in the facility I at time t₀, exposing the area P to risk. This even may be real or simulated. During a first step 110, a risk propagation area C in the area P is estimated based on at least: on one hand, information issuing from measurements on the type and extent of the accident; and, on the other hand, on environmental and/or meteorological data such as the speed and direction of the wind within the area P starting at time t₀. Then the risk propagation area C corresponding to a subset of the area P is determined in which the hazard is likely to be distributed. In the case of a radiological hazard, the information on the accident is for example the amount of radioactive material likely to have been released and possibly their type, and the environmental data: the speed and direction of the wind, precipitation, etc. In this example, the risk propagation area C is the section of the disk represented in FIG. 1 having a tip corresponding to the position of the facility I, and the area is determined as a function of the speed and direction of the wind.

Then, in a second step 120, a subset of points m is selected from among the different points m in the area P which are also contained in the risk propagation area C.

In a third step 130, measurement tasks are planned at the points m which are part of the subset of points m obtained during the second step 120. To do this, based on the inventory of material and operational resources available, task assignments are constructed and assigned to operators, indicating for example one of the points m, a type of measurement the operator is to perform, the measurement device which is to be used, the time, and the corresponding priority of this task.

In a fourth step 140, the measurements made during the task assignments at the selected points m are received, validated, and stored in a database system. The validation of the measurements may involve verifying the consistency of the measurement as a function of its evolution over time and/or its consistency relative to the measurements obtained nearby.

In a fifth step 150, a summary view of the situation in the area P is constructed and made available. The summary view of the situation may in particular comprise a map of the area P comprising a representation of the propagation of the risk over time, and/or representations over time in text, table, and/or graphical form of measurements previously obtained.

The method described may also be carried out as part of a simulation exercise.

1. A method for evaluating a situation of exposure to risk in an area by conducting measurements at different points in the area, wherein said method comprises the following steps:
estimating a risk propagation area within the area, based on at least: on one hand, information issuing from measurements on the type and extent of the risk; and, on the other hand, on environmental and/or meteorological data comprising in particular the speed and direction of the wind within said area starting at an initial time;
selecting a subset of points, from among the different points in the area, also contained in the risk propagation area; and
planning measurement tasks at the points of the subset.

2. The method according to claim 1, wherein the measurements at the different points of the area are radiological measurements, the risk propagation area being estimated on the basis of a measurement of said environmental and/or meteorological data.

3. The method according to claim 2, wherein the risk propagation area is estimated on the basis of a measurement of the speed and direction of the wind within the area.

4. The method according to claim 1, further comprising a step of receiving, validating, and storing the measurements made during the planned measurement tasks.

5. The method according to claim 4, wherein the measurements made during the measurement tasks are validated by verifying the consistency of each measurement as a function of its evolution over time and/or its consistency relative to other measurements obtained nearby.

6. The method according to claim 4, further comprising a step of constructing and making available a summary view of the situation in the area, based on the stored measurements.

7. The method according to claim 6, wherein the summary view of the situation in the area comprises:
a map of the area comprising a representation of the risk propagation over time; and
representations over time, in text, table, and/or graphical form, of the measurements previously obtained.

8. The method according to claim 1, wherein the different points in the area are predefined.

9. The method according to claim 1, wherein the measurement tasks at the points are planned by assigning, to the operators, task assignments comprising the following information:
one of the points in the subset;
a type of measurement to be performed; and
a measurement device to be used.

10. A use of a method according claim 1, in the context of a simulation exercise.

11. A computer program comprising instructions for implementing the method according to claim 1 when this program is executed by a processor.

12. A system for evaluating a situation of risk exposure in an area, comprising:
measurement devices for performing measurements at different points (m) of the area in order to assess the risk;
a measurement control center adapted to:
estimate a risk propagation area in the area;
select a subset of points, from among the different points of the area, which are also contained in the risk propagation area;
plan measurement tasks at the points of the subset; and
a network infrastructure to interconnect the measurement devices and the measurement control center.

13. The system according to claim 12, wherein the measurement devices are able to obtain radiological measurements at different points of the area, the measurement control center being adapted to estimate the risk propagation area within the area based on a measurement of meteorological conditions.

14. The system according to claim 13, wherein the measurement control center is adapted to estimate the risk propagation area on the basis of a measurement of the speed and direction of the wind within the area.

15. The system according to claim 12, wherein the measurement control center is adapted to receive and validate the measurements obtained by means of the measurement devices during the measurement tasks.

16. The system according to claim 15, further comprising a measurement storage center, connected to the network infrastructure and adapted to store the measurements obtained during the measurement tasks by means of the measurement devices.

17. The system according to claim 16, wherein the measurement storage center is adapted to construct and make available a summary view of the situation in the area based on the stored measurements.

18. The system according to claim 17, wherein the storage center comprises:
a database server for storing measurement and associated information sent by the measurement devices;
a geographical information server for creating a graphical representation of the area and of the measurements contained in the database server; and
a web server for generating pages containing a summary view of the situation in the area, based on measurements contained in the database server.

19. The system according to claim 17, wherein the summary view of the situation in the area comprises:
a map of the area comprising a representation of the risk propagation over time; and
representations over time, in text, table, and/or graphical form, of the measurements previously obtained.

20. The system according to claim 17, further comprising a monitoring and decision center connected to the network infrastructure to access the pages comprising a summary view of the situation in the area produced by the database server.

21. A measurement device for a system according to claim 12, comprising:
a network interface for establishing a connection to the network infrastructure;
at least one sensor, able to perform physical measurements for assessing the risk;
a locator unit for determining the geographical position of the measurement device;
a calculation unit, cooperating with a user interface, the network interface, and the locator unit, adapted to:
display an interactive map of the area on the user interface;
provide instructional and task sheets containing information concerning the measurement points;
capture, store, and display measurements obtained using the sensor; and
transmit measurements over the network interface.
